(19) United States
(12) Patent Application Publication
(10) Pub. No.: US 2024/0172260 A1
(43) Pub. Date: May 23, 2024

(54) TECHNIQUE TO IMPROVE THROUGHPUT ESTIMATION ACCURACY IN ALL WIRELESS MODEM RADIO CONDITIONS

(71) Applicant: QUALCOMM Incorporated, San Diego, CA (US)

(72) Inventors: Rajashekar CHILLA, San Diego, CA (US); Vijay Kumar BOLLENI, San Diego, CA (US)

(21) Appl. No.: 18/057,014

(22) Filed: Nov. 18, 2022

(51) Int. Cl. H04W 72/12

(52) U.S. Cl. CPC H04W 72/1252

(57) ABSTRACT

Some techniques described herein provide identification of a throughput estimate using a throughput estimation technique that is selected in accordance with an adjustable threshold. For example, the adjustable threshold may be based at least in part on a scheduling rate of a user equipment. In some aspects, the threshold may be adjustable based at least in part on a scheduling rate and a moving average derived from the scheduling rate. For example, the threshold may change over time based at least in part on a moving average derived from a past value of the scheduling rate and/or a current value of the scheduling rate. Thus, the threshold may decrease over time when the scheduling rate is relatively low (e.g., lower than the threshold), and may increase over time when the scheduling rate is relatively high (e.g., higher than the threshold).

### FIELD OF THE DISCLOSURE

Aspects of the present disclosure generally relate to wireless communication and to techniques and apparatuses for throughput estimation technique switching.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. 5G, which may be referred to as New Radio (NR), is a set of enhancements to the LTE mobile standard promulgated by the 3GPP. 5G is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in 4G, 5G, and other radio access technologies remain useful.

### SUMMARY

A user equipment (UE) may support various services using data communication, control communication, or a combination thereof. Some services may benefit from an estimation of the throughput achievable by the UE. A throughput is a data rate, often represented as a volume of data (bits, bytes, packets, etc.) per unit of time. This volume of data can include data of data communication, data of control communication, or both. A UE may estimate the throughput achievable by the UE (e.g., a modem of the UE, a network connection of the UE), referred to herein as a throughput estimate. For example, the UE (e.g., a modem of the UE) may provide or expose the throughput estimate to an application processor of the UE. The throughput estimate can be based on various factors, such as a theoretical maximum throughput (which is a function of a duplexing configuration, a number of component carriers, a number of multiple-input multiple-output (MIMO) layers, a modulation and coding scheme, a bandwidth, an overhead, and/or other factors), an observed data rate, a power headroom, and/or other factors. A UE can use different throughput estimation techniques to determine a throughput estimate. In some examples, different throughput estimation techniques may be suitable in different scenarios. For example, a first throughput estimation technique may provide more accurate throughput estimates during periods of data transfer, and a second throughput estimation technique may provide more accurate throughput estimates outside periods of data transfer.

Some UEs may use a fixed threshold for switching between different throughput estimation techniques. For example, the fixed threshold may be a scheduling rate value (e.g., a 50% scheduling rate, indicating that 50% of resources, such as 50% of slots, are scheduled). When a scheduling rate of the UE satisfies the fixed threshold (for example, indicating a period of high data transfer), the UE may use a first throughput estimation technique (which may be suitable for periods of data transfer). When a scheduling rate of the UE fails to satisfy the fixed threshold (for example, indicating a period of low or no data transfer), the UE may use a second throughput estimation technique (which may be suitable for periods of low or no data transfer). However, a fixed threshold for selection of a throughput estimation technique may lead to inaccurate throughput estimation in some scenarios. For example, if a fixed threshold for scheduling rate is set at a value that is higher than a typical scheduling rate for a data transfer, then the UE may not switch to a throughput estimation technique suitable for data transfer during the data transfer. As another example, if the fixed threshold for scheduling rate is set at a value that is lower than a typical scheduling rate for a data transfer, then the UE may switch to a throughput technique suitable for data transfer when no data transfer is actually occurring. Furthermore, scheduling rate can vary due to factors other than whether data transfer is occurring, such as load and resource availability. Therefore, switching between throughput estimation techniques according to a fixed threshold for scheduling rate may lead to inaccurate throughput estimation, thereby causing underutilization of network resources, delays in communication, and failure to meet quality of service parameters or user expectations.

Some techniques described herein provide identification of a throughput estimate using a throughput estimation technique that is selected in accordance with an adjustable threshold. For example, the adjustable threshold may be based at least in part on a scheduling rate of the UE. In some aspects, the threshold may be adjustable based at least in part on a scheduling rate and a moving average derived from the scheduling rate. For example, the threshold may change over time based at least in part on a moving average derived from a past value of the scheduling rate and/or a current value of the scheduling rate. Thus, the threshold may decrease over time when the scheduling rate is relatively low (e.g., lower than the threshold), and may increase over time when the scheduling rate is relatively high (e.g., higher than the threshold). Thus, accuracy of throughput estimation is increased, since the threshold may more accurately select for an appropriate throughput estimation technique. Thus, utilization of network resources is improved, thereby reducing delays in communication and improving adherence to quality of service parameters.

Some aspects described herein relate to a method of wireless communication performed by a UE. The method may include identifying a first throughput estimate using a first throughput estimation technique based at least in part on a threshold being satisfied at a first time, wherein the threshold is adjustable based at least in part on a scheduling rate of the UE. The method may include identifying a second throughput estimate using a second throughput estimation technique based at least in part on the threshold not being satisfied at a second time. The method may include communicating based at least in part on the first throughput estimate or the second throughput estimate.

Some aspects described herein relate to a UE for wireless communication. The user equipment may include a memory and one or more processors coupled to the memory. The one or more processors may be configured to identify a first throughput estimate using a first throughput estimation technique based at least in part on a threshold being satisfied at a first time, wherein the threshold is adjustable based at least in part on a scheduling rate of the UE. The one or more processors may be configured to identify a second throughput estimate using a second throughput estimation technique based at least in part on the threshold not being satisfied at a second time. The one or more processors may be configured to communicate based at least in part on the first throughput estimate or the second throughput estimate.

Some aspects described herein relate to a non-transitory computer-readable medium that stores a set of instructions for wireless communication by a UE. The set of instructions, when executed by one or more processors of the UE, may cause the UE to identify a first throughput estimate using a first throughput estimation technique based at least in part on a threshold being satisfied at a first time, wherein the threshold is adjustable based at least in part on a scheduling rate of the UE. The set of instructions, when executed by one or more processors of the UE, may cause the UE to identify a second throughput estimate using a second throughput estimation technique based at least in part on the threshold not being satisfied at a second time. The set of instructions, when executed by one or more processors of the UE, may cause the UE to communicate based at least in part on the first throughput estimate or the second throughput estimate.

Some aspects described herein relate to an apparatus for wireless communication. The apparatus may include means for identifying a first throughput estimate using a first throughput estimation technique based at least in part on a threshold being satisfied at a first time, wherein the threshold is adjustable based at least in part on a scheduling rate of the apparatus. The apparatus may include means for identifying a second throughput estimate using a second throughput estimation technique based at least in part on the threshold not being satisfied at a second time. The apparatus may include means for communicating based at least in part on the first throughput estimate or the second throughput estimate.

Aspects generally include a method, apparatus, system, computer program product, non-transitory computer-readable medium, user equipment, base station, wireless communication device, network entity, network node, and/or processing system as substantially described with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of a user plane protocol stack and a control plane protocol stack for a network node and a core network in communication with a UE, in accordance with the present disclosure.

FIG. 4 is a diagram illustrating an example of throughput estimation based at least in part on an adjustable threshold, in accordance with the present disclosure.

FIG. 5 is a diagram illustrating an example process performed, for example, by a UE, in accordance with the present disclosure.

FIG. 6 is a diagram of an example apparatus for wireless communication, in accordance with the present disclosure.

FIG. 7 is a diagram illustrating an example of a hardware implementation for an apparatus employing a processing system, in accordance with the present disclosure.

### DETAILED DESCRIPTION

The detailed description set forth below in connection with the appended drawings is intended as a description of various configurations and is not intended to represent the configurations in which the concepts described herein may be practiced. The detailed description includes specific details for the purposes of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, or the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, or the like, whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

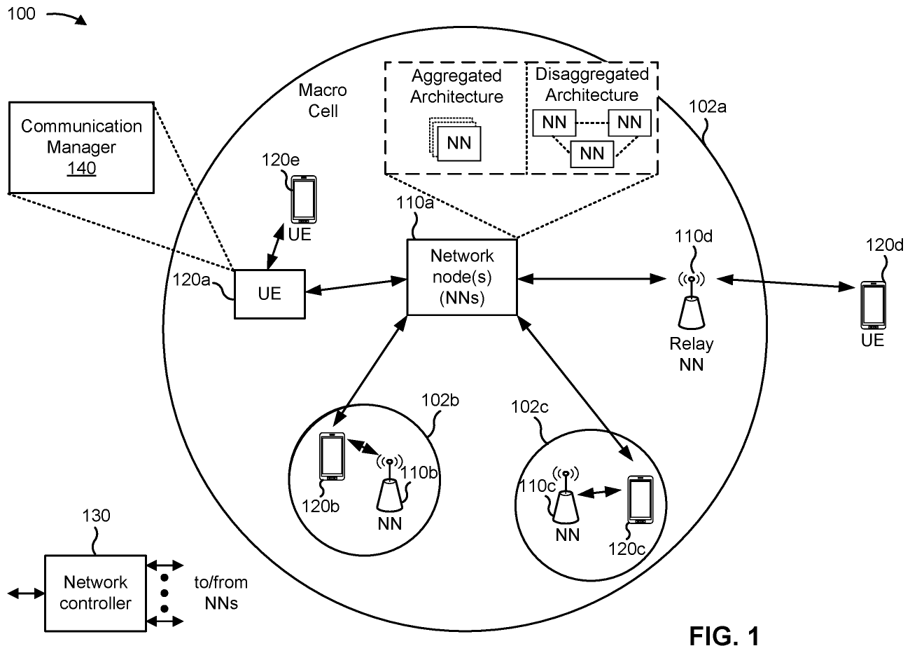

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing 284 that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may identify a first throughput estimate using a first throughput estimation technique based at least in part on a threshold being satisfied at a first time, wherein the threshold is adjustable based at least in part on a scheduling rate of the UE; identify a second throughput estimate using a second throughput estimation technique based at least in part on the threshold not being satisfied at a second time; and communicate based at least in part on the first throughput estimate or the second throughput estimate. Additionally, or alternatively, the communication manager 140 may perform one or more other operations described herein.

As indicated above, FIG. 1 is provided as an example. Other examples may differ from what is described with regard to FIG. 1.

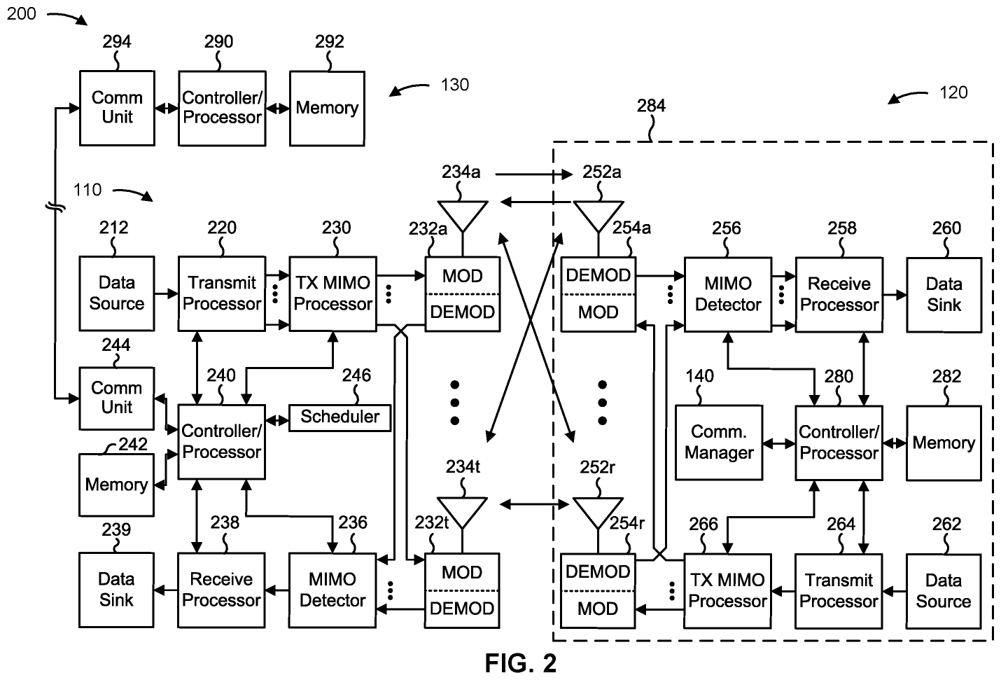

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MC S(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein.

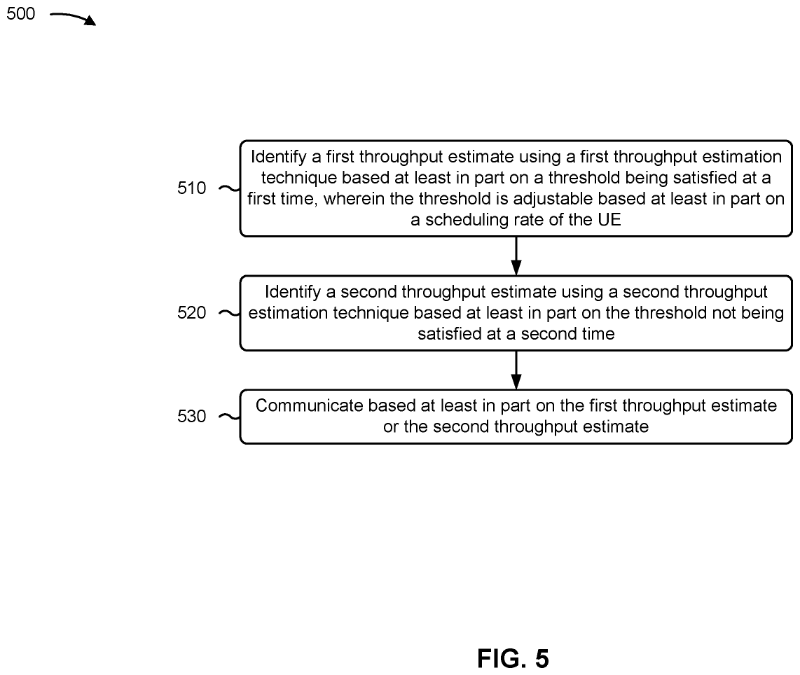

The controller/processor 240 of the network node 110, the controller/processor 280 of the UE 120, and/or any other component(s) of FIG. 2 may perform one or more techniques associated with throughput estimation, as described in more detail elsewhere herein. For example, the controller/processor 240 of the network node 110, the controller/processor 280 of the UE 120, and/or any other component(s) of FIG. 2 may perform or direct operations of, for example, process 500 of FIG. 5, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 500 of FIG. 5, and/or other processes as described herein. In some examples, executing instructions may include running the instructions, converting the instructions, compiling the instructions, and/or interpreting the instructions, among other examples.

In some aspects, a UE (e.g., UE 120) includes means for identifying a first throughput estimate using a first throughput estimation technique based at least in part on a threshold being satisfied at a first time, wherein the threshold is adjustable based at least in part on a scheduling rate of the UE; means for identifying a second throughput estimate using a second throughput estimation technique based at least in part on the threshold not being satisfied at a second time; and/or means for communicating based at least in part on the first throughput estimate or the second throughput estimate. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

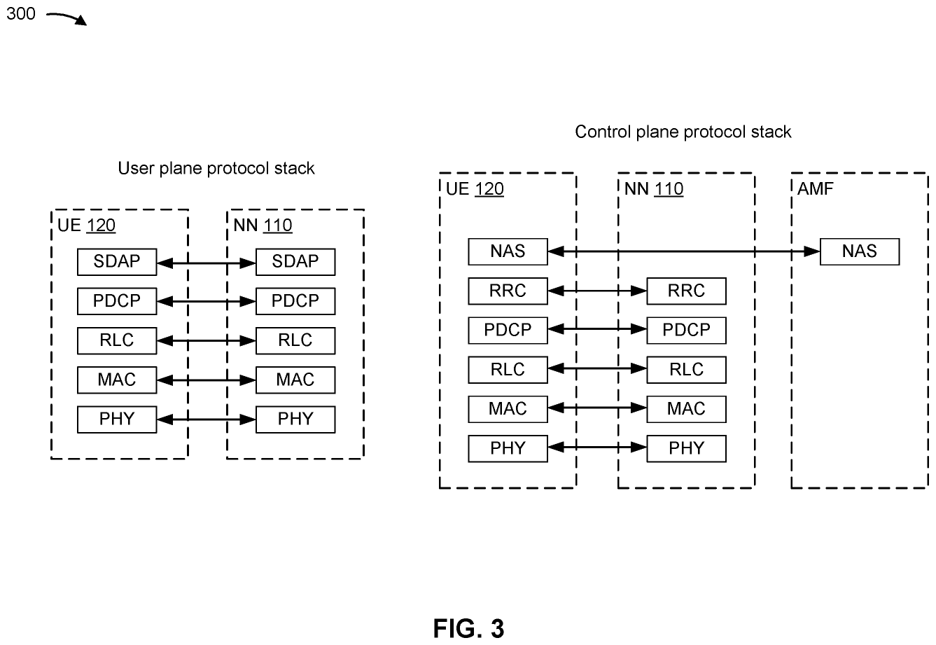

FIG. 3 is a diagram illustrating an example 300 of a user plane protocol stack and a control plane protocol stack for a network node 110 and a core network in communication with a UE 120, in accordance with the present disclosure. In some aspects, the network node 110 may include a plurality of network nodes 110. In some aspects, protocol stack functions of the network node 110 may be distributed across multiple network nodes 110. For example, a first network node 110 may implement a first layer of a protocol stack, and a second network node 110 may implement a second layer of the protocol stack. The distribution of the protocol stack across network nodes (in examples where the protocol stack is distributed across network nodes) may be based at least in part on a functional split, as described elsewhere herein. It should be understood that references to “a network node 110” or “the network node 110” can, in some aspects, refer to multiple network nodes.

On the user plane, the UE 120 and the network node 110 may include respective physical (PHY) layers, medium access control (MAC) layers, radio link control (RLC) layers, packet data convergence protocol (PDCP) layers, and service data adaptation protocol (SDAP) layers. A user plane function may handle transport of user data between the UE 120 and the network node 110. On the control plane, the UE 120 and the network node 110 may include respective radio resource control (RRC) layers. Furthermore, the UE 120 may include a non-access stratum (NAS) layer in communication with an NAS layer of an access and management mobility function (AMF). The AMF may be associated with a core network associated with the network node 110, such as a 5G core network (5GC) or a next-generation radio access network (NG-RAN). A control plane function may handle transport of control information between the UE and the core network. Generally, a first layer is referred to as higher than a second layer if the first layer is further from the PHY layer than the second layer. For example, the PHY layer may be referred to as a lowest layer, and the SDAP/PDCP/RLC/MAC layer may be referred to as higher than the PHY layer and lower than the RRC layer. An application (APP) layer, not shown in FIG. 3, may be higher than the SDAP/PDCP/RLC/MAC layer. In some cases, an entity may handle the services and functions of a given layer (e.g., a PDCP entity may handle the services and functions of the PDCP layer), though the description herein refers to the layers themselves as handling the services and functions.

The RRC layer may handle communications related to configuring and operating the UE 120, such as: broadcast of system information related to the access stratum (AS) and the NAS; paging initiated by the 5GC or the NG-RAN; establishment, maintenance, and release of an RRC connection between the UE and the NG-RAN, including addition, modification, and release of carrier aggregation, as well as addition, modification, and release of dual connectivity; security functions including key management; establishment, configuration, maintenance, and release of signaling radio bearers (SRBs) and data radio bearers (DRBs); mobility functions (e.g., handover and context transfer, UE cell selection and reselection and control of cell selection and reselection, inter-RAT mobility); quality of service (QoS) management functions; UE measurement reporting and control of the reporting; detection of and recovery from radio link failure; and NAS message transfer between the NAS layer and the lower layers of the UE 120. The RRC layer is frequently referred to as Layer 3 (L3).

The SDAP layer, PDCP layer, RLC layer, and MAC layer may be collectively referred to as Layer 2 (L2). Thus, in some cases, the SDAP, PDCP, RLC, and MAC layers are referred to as sublayers of Layer 2. On the transmitting side (e.g., if the UE 120 is transmitting an uplink communication or the network node 110 is transmitting a downlink communication), the SDAP layer may receive a data flow in the form of a QoS flow. A QoS flow is associated with a QoS identifier, which identifies a QoS parameter associated with the QoS flow, and a QoS flow identifier (QFI), which identifies the QoS flow. Policy and charging parameters are enforced at the QoS flow granularity. A QoS flow can include one or more service data flows (SDFs), so long as each SDF of a QoS flow is associated with the same policy and charging parameters. In some aspects, the RRC/NAS layer may generate control information to be transmitted and may map the control information to one or more radio bearers for provision to the PDCP layer.

The SDAP layer, or the RRC/NAS layer, may map QoS flows or control information to radio bearers. Thus, the SDAP layer may be said to handle QoS flows on the transmitting side. The SDAP layer may provide the QoS flows to the PDCP layer via the corresponding radio bearers. The PDCP layer may map radio bearers to RLC channels. The PDCP layer may handle various services and functions on the user plane, including sequence numbering, header compression and decompression (if robust header compression is enabled), transfer of user data, reordering and duplicate detection (if in-order delivery to layers above the PDCP layer is required), PDCP protocol data unit (PDU) routing (in case of split bearers), retransmission of PDCP service data units (SDUs), ciphering and deciphering, PDCP SDU discard (e.g., in accordance with a timer, as described elsewhere herein), PDCP re-establishment and data recovery for RLC acknowledged mode (AM), and duplication of PDCP PDUs. The PDCP layer may handle similar services and functions on the control plane, including sequence numbering, ciphering, deciphering, integrity protection, transfer of control plane data, duplicate detection, and duplication of PDCP PDUs.

The PDCP layer may provide data, in the form of PDCP PDUs, to the RLC layer via RLC channels. The RLC layer may handle transfer of upper layer PDUs to the MAC and/or PHY layers, sequence numbering independent of PDCP sequence numbering, error correction via automatic repeat requests (ARQ), segmentation and re-segmentation, reassembly of an SDU, RLC SDU discard, and RLC re-establishment.

The RLC layer may provide data, mapped to logical channels, to the MAC layer. The services and functions of the MAC layer include mapping between logical channels and transport channels (used by the PHY layer as described below), multiplexing/demultiplexing of MAC SDUs belonging to one or different logical channels into/from transport blocks (TBs) delivered to/from the physical layer on transport channels, scheduling information reporting, error correction through hybrid ARQ (HARD), priority handling between UEs by means of dynamic scheduling, priority handling between logical channels of one UE by means of logical channel prioritization, and padding.

The MAC layer may package data from logical channels into TBs, and may provide the TBs on one or more transport channels to the PHY layer. The PHY layer may handle various operations relating to transmission of a data signal, as described in more detail in connection with FIG. 2. The PHY layer is frequently referred to as Layer 1 (L1).

On the receiving side (e.g., if the UE 120 is receiving a downlink communication or the network node 110 is receiving an uplink communication), the operations may be similar to those described for the transmitting side, but reversed. For example, the PHY layer may receive TBs and may provide the TBs on one or more transport channels to the MAC layer. The MAC layer may map the transport channels to logical channels and may provide data to the RLC layer via the logical channels. The RLC layer may map the logical channels to RLC channels and may provide data to the PDCP layer via the RLC channels. The PDCP layer may map the RLC channels to radio bearers and may provide data to the SDAP layer or the RRC/NAS layer via the radio bearers.

Data may be passed between the layers in the form of PDUs and SDUs. An SDU is a unit of data that has been passed from a layer or sublayer to a lower layer. For example, the PDCP layer may receive a PDCP SDU. A given layer may then encapsulate the unit of data into a PDU and may pass the PDU to a lower layer. For example, the PDCP layer may encapsulate the PDCP SDU into a PDCP PDU and may pass the PDCP PDU to the RLC layer. The RLC layer may receive the PDCP PDU as an RLC SDU, may encapsulate the RLC SDU into an RLC PDU, and so on. In effect, the PDU carries the SDU as a payload.

As indicated above, FIG. 3 is provided as an example. Other examples may differ from what is described with regard to FIG. 3.

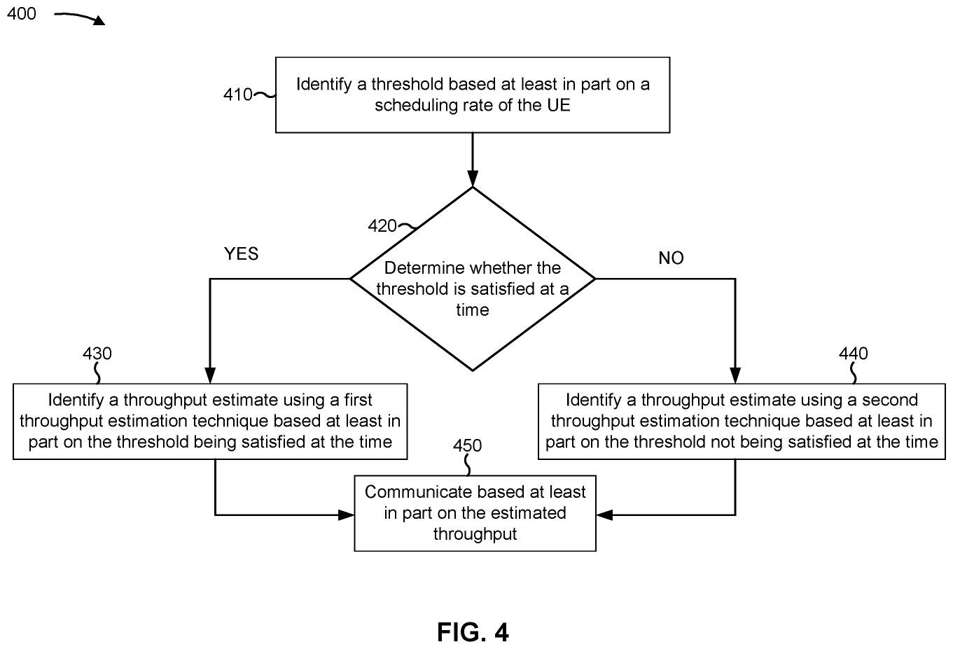

FIG. 4 is a diagram illustrating an example 400 of throughput estimation based at least in part on an adjustable threshold, in accordance with the present disclosure. The operations of example 400 may be performed by a UE (e.g., UE 120).

As shown by reference number 410, the UE may identify a threshold based at least in part on a scheduling rate of the UE. For example, the UE may identify a value of the scheduling rate as the threshold. In some aspects, the value of the scheduling rate may differ from a current (e.g., observed) scheduling rate of the UE. For example, the value of the scheduling rate may be derived from the current scheduling rate of the UE.

In some aspects, the threshold may be adjustable based at least in part on the scheduling rate and a moving average derived from the scheduling rate. A moving average of a parameter (e.g., a scheduling rate) may be based at least in part on multiple values of the parameter, wherein at least one value of the parameter is a historical (e.g., past) value of the parameter or is derived from a historical value of the parameter.

In some aspects, the moving average may allocate a higher weight to more recent values of the scheduling rate than to less recent values of the scheduling rate. For example, the threshold may be based at least in part on an exponential moving average (EMA) derived from the scheduling rate of the UE. An EMA (sometimes referred to as an exponentially weighted moving average) at a time t (EMAₜ) may be based on an average standard deviation at the time t (ASDₜ), a standard deviation at the time t (SDt), a scheduling rate (SR) (e.g., an average scheduling rate), a smoothing value (smoothing), and a sample value (sample). ASDₜ may be determined as

$$( \frac{{ASD}_{t - 1} + {SD}_{t}}{2} ) .$$

EMAₜ may be determined as

$$( {ASR}_{t} * ( \frac{Smoothing}{1 + sample} ) ) + ( {EMA}_{t - 1} * ( \frac{Smoothing}{1 + sample} ) ) .$$

Thus, the EMA takes into account a prior EMA with a weight of

$$( 1 - \frac{Smoothing}{1 + sample} )$$

and an average scheduling rate with a weight of

$$\frac{Smoothing}{1 + sample} ,$$

thereby assigning a higher weight to the more recent average scheduling rate than the less recent prior exponential moving average. The threshold at a time t+1 (Thresholdₜ₊₁) may be determined as Max((EMAₜ−2*ASDₜ), 20) (that is, the maximum of a 20% scheduling rate and a scheduling rate derived as EMAₜ minus two times ASDₜ). Thus, the threshold is prevented from dropping to zero or near-zero in times of low scheduling rate. Determination of the threshold (and the throughput estimation technique) using the EMA as the threshold may conserve processor resources relative to more complex techniques for determining the threshold.

In some aspects, the threshold may be based at least in part on a moving average convergence divergence (MACD) value. An MACD value indicates a relationship between a first EMA and a second EMA, wherein the first EMA and the second EMA are derived from a historical scheduling rate of the UE. The UE may combine the first EMA and the second EMA to determine a MACD value, and may derive a signal value from a number of historical MACD values. The threshold may be derived from a relationship between a current MACD value at a time t (MACDₜ) and the signal value at the time t (SIGNALₜ). For example, the threshold may be determined as MACDₜ-SIGNALₜ, as shown below. Thus, the UE may use a momentum indicator (e.g., MACDₜ-SIGNALₜ), indicating a relationship between the first EMA and the second EMA.

The first EMA (EMA₂₆₍ₜ₎) may use a first sample value (e.g., 26, though other values may be used) and the second EMA (EMA₁₂₍ₜ₎) may use a second sample value (e.g., 12, though other values may be used). The UE may determine the first EMA and the second EMA may be determined as described above with regard to the determination of EMAₜ:

$$\begin{matrix}{EMA}_{26} ( t ) = ( {SR}_{t} * ( \frac{Smoothing}{27} ) ) + ( {EMA}_{26} ( t - 1 ) * ( 1 - \frac{Smoothing}{27} ) ) \\ {EMA}_{12} ( t ) = ( {SR}_{t} * ( \frac{Smoothing}{13} ) ) + ( {EMA}_{12} ( t - 1 ) * ( 1 - \frac{Smoothing}{13} ) )\end{matrix}$$

MACDₜ may be determined as MACDₜ=EMA₂₆ (t)−EMA₁₂ (t). SIGNALₜ may be determined as:

$${SIGNAL}_{t} = ( {MACD}_{t} * ( \frac{Smoothing}{10} ) ) + ( {MACD}_{t - 1} * ( 1 - \frac{Smoothing}{10} ) ) .$$

The threshold, at time t, may be determined as SIGNALₜ. If MACDₜ is greater than SIGNALₜ, then the UE may use a first throughput estimation technique (e.g., a burst throughput estimation technique). If MACDₜ is less than SIGNALₜ, then the UE may use a second throughput estimation technique (e.g., a link quality estimation throughput estimation technique). If MACDₜ is equal to SIGNALₜ, then the UE may use a same throughput estimation technique as at time t−1.

As shown by reference number 420, the UE may determine whether the threshold is satisfied at a time. For example, the UE may determine whether a scheduling rate at a time t is greater than (or, in some aspects, greater than or equal to) Max((EMAₜ−2*ASDₜ), 20). As another example, the UE may determine whether MACDₜ is greater than SIGNALₜ.

As shown by reference number 430, if the threshold is satisfied at the time (reference number 420—YES), then the UE may identify a throughput estimate using a first throughput estimation technique based at least in part on the threshold being satisfied at the time. For example, the UE may identify the throughput estimate using a first throughput estimation technique in response to the threshold being satisfied at the time. As another example, the UE may switch to the first throughput estimation technique at the time in response to the threshold being satisfied at the time. As yet another example, the UE may output, to an application processor of the UE, the throughput estimate, as determined using the first throughput estimation technique. In some aspects, the throughput may be satisfied at the time when a current scheduling rate (e.g., SRₜ) is greater than (or greater than or equal to) Max((EMAₜ−2*ASDₜ), 20). In some aspects, the throughput may be satisfied at the time when MACDₜ is greater than SIGNALₜ.

As shown by reference number 440, if the threshold is not satisfied at the time (reference number 420—NO), then the UE may identify a throughput estimate using a second throughput estimation technique based at least in part on the threshold not being satisfied at the time. For example, the UE may identify the throughput estimate using a second throughput estimation technique in response to the threshold not being satisfied at the time. As another example, the UE may switch to the first throughput estimation technique at the time in response to the threshold not being satisfied at the time. As yet another example, the UE may output, to an application processor of the UE, the throughput estimate, as determined using the second throughput estimation technique. In some aspects, the throughput may not be satisfied at the time when a current scheduling rate (e.g., SRₜ) is less than or equal to (or less than) Max((EMAₜ−2*ASDₜ), 20). In some aspects, the throughput may be satisfied at the time when MACDₜ is less than SIGNALₜ.

In some aspects, the first throughput estimation technique may be based at least in part on an observed data rate at a layer of the UE higher than a physical layer. For example, the UE may determine an observed data rate at, for example, a MAC layer, an RRC layer, an application layer, or the like. The first throughput estimation technique may use this observed data rate as an input. For example, the estimated throughput may be equal to the observed data rate. As another example, the estimated throughput may be derived from the observed data rate (e.g., based at least in part on a moving average or the like). In some aspects, the first throughput estimation technique may provide more accurate throughput estimation than the second throughput estimation technique during data transfer.

In some aspects, the second throughput estimation technique may be based at least in part on the scheduling rate at the time t. For example, the second throughput estimation technique may be based at least in part on the scheduling rate and a power headroom of the UE. For example, the UE (e.g., a physical layer of the UE) may determine the scheduling rate and the power headroom. The first throughput estimation technique may use the scheduling rate and the power headroom as an input. In some aspects, the second throughput estimation technique may provide more accurate throughput estimation than the first throughput estimation technique when data transfer is not actively occurring. In some aspects, the second throughput estimation technique may be based at least in part on a link quality (e.g., as indicated by the power headroom and/or another parameter) of the UE.

As shown by reference number 450, the UE may communicate based at least in part on the estimated throughput. For example, the UE may transmit a communication using a configuration derived from the estimated throughput. As another example, the UE may select a packet size, or may split a communication across a number of packets or transmissions, in accordance with the estimated throughput. As another example, the UE may configure a service in accordance with the estimated throughput.

As indicated above, FIG. 4 is provided as an example. Other examples may differ from what is described with regard to FIG. 4.

FIG. 5 is a diagram illustrating an example process 500 performed, for example, by a UE, in accordance with the present disclosure. Example process 500 is an example where the UE (e.g., UE 120) performs operations associated with throughput estimation technique switching.

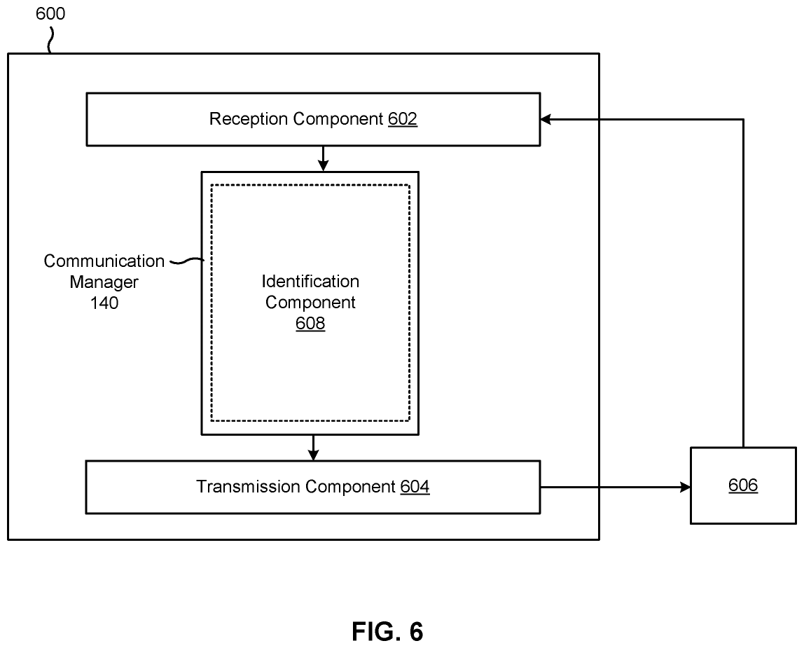

As shown in FIG. 5, in some aspects, process 500 may include identifying a first throughput estimate using a first throughput estimation technique based at least in part on a threshold being satisfied at a first time, wherein the threshold is adjustable based at least in part on a scheduling rate of the UE (block 510). For example, the UE (e.g., using communication manager 140 and/or identification component 608, depicted in FIG. 6) may identify a first throughput estimate using a first throughput estimation technique based at least in part on a threshold being satisfied at a first time, wherein the threshold is adjustable based at least in part on a scheduling rate of the UE, as described above.

As further shown in FIG. 5, in some aspects, process 500 may include identifying a second throughput estimate using a second throughput estimation technique based at least in part on the threshold not being satisfied at a second time (block 520). For example, the UE (e.g., using communication manager 140 and/or identification component 608, depicted in FIG. 6) may identify a second throughput estimate using a second throughput estimation technique based at least in part on the threshold not being satisfied at a second time, as described above.

As further shown in FIG. 5, in some aspects, process 500 may include communicating based at least in part on the first throughput estimate or the second throughput estimate (block 530). For example, the UE (e.g., using communication manager 140 and/or transmission component 604, depicted in FIG. 6) may communicate based at least in part on the first throughput estimate or the second throughput estimate, as described above.

Process 500 may include additional aspects, such as any single aspect or any combination of aspects described below and/or in connection with one or more other processes described elsewhere herein.

In a first aspect, the threshold is associated with a value of the scheduling rate.

In a second aspect, alone or in combination with the first aspect, the threshold is adjustable based at least in part on the scheduling rate and a moving average derived from the scheduling rate.

In a third aspect, alone or in combination with one or more of the first and second aspects, the moving average comprises an exponential moving average.

In a fourth aspect, alone or in combination with one or more of the first through third aspects, the moving average is based at least in part on a moving average convergence divergence technique.

In a fifth aspect, alone or in combination with one or more of the first through fourth aspects, the first throughput estimation technique is based at least in part on an observed data rate at a layer of the UE higher than a physical layer.

In a sixth aspect, alone or in combination with one or more of the first through fifth aspects, the second throughput estimation technique is based at least in part on the scheduling rate and a power headroom of the UE.

In a seventh aspect, alone or in combination with one or more of the first through sixth aspects, process 500 includes switching between the first throughput estimation technique and the second throughput estimation technique based at least in part on a current value of the threshold.

In an eighth aspect, alone or in combination with one or more of the first through seventh aspects, process 500 includes determining the threshold based at least in part on the scheduling rate.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication, in accordance with the present disclosure. The apparatus 600 may be a UE, or a UE may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include the communication manager 140. The communication manager 140 may include an identification component 608, among other examples.

In some aspects, the apparatus 600 may be configured to perform one or more operations described herein in connection with FIG. 4. Additionally, or alternatively, the apparatus 600 may be configured to perform one or more processes described herein, such as process 500 of FIG. 5, or a combination thereof. In some aspects, the apparatus 600 and/or one or more components shown in FIG. 6 may include one or more components of the UE described in connection with FIG. 2. Additionally, or alternatively, one or more components shown in FIG. 6 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 600. In some aspects, the reception component 602 may include one or more antennas, a modem, a demodulator, a MIMO detector, a receive processor, a controller/processor, a memory, or a combination thereof, of the UE described in connection with FIG. 2.

The transmission component 604 may transmit communications, such as reference signals, control information, data communications, or a combination thereof, to the apparatus 606. In some aspects, one or more other components of the apparatus 600 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modem, a modulator, a transmit MIMO processor, a transmit processor, a controller/processor, a memory, or a combination thereof, of the UE described in connection with FIG. 2. In some aspects, the transmission component 604 may be co-located with the reception component 602 in a transceiver.

The identification component 608 may identify a first throughput estimate using a first throughput estimation technique based at least in part on a threshold being satisfied at a first time, wherein the threshold is adjustable based at least in part on a scheduling rate of the UE. The identification component 608 may identify a second throughput estimate using a second throughput estimation technique based at least in part on the threshold not being satisfied at a second time. The transmission component 604 may communicate based at least in part on the first throughput estimate or the second throughput estimate.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

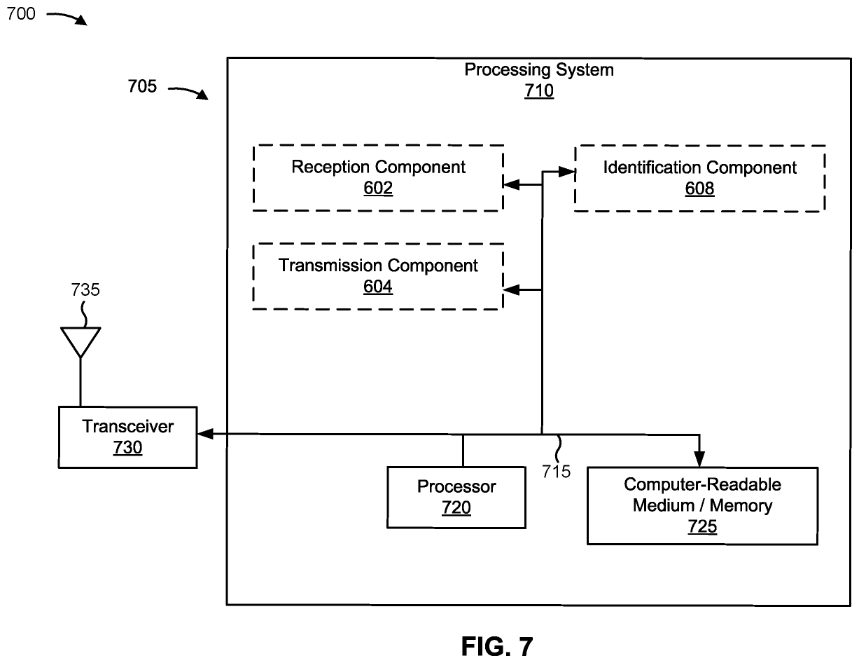

FIG. 7 is a diagram illustrating an example 700 of a hardware implementation for an apparatus 705 employing a processing system 710, in accordance with the present disclosure. The apparatus 705 may be a UE.

The processing system 710 may be implemented with a bus architecture, represented generally by the bus 715. The bus 715 may include any number of interconnecting buses and bridges depending on the specific application of the processing system 710 and the overall design constraints. The bus 715 links together various circuits including one or more processors and/or hardware components, represented by the processor 720, the illustrated components, and the computer-readable medium/memory 725. The bus 715 may also link various other circuits, such as timing sources, peripherals, voltage regulators, and/or power management circuits.

The processing system 710 may be coupled to a transceiver 730. The transceiver 730 is coupled to one or more antennas 735. The transceiver 730 provides a means for communicating with various other apparatuses over a transmission medium. The transceiver 730 receives a signal from the one or more antennas 735, extracts information from the received signal, and provides the extracted information to the processing system 710, specifically the reception component 602. In addition, the transceiver 730 receives information from the processing system 710, specifically the transmission component 604, and generates a signal to be applied to the one or more antennas 735 based at least in part on the received information.

The processing system 710 includes a processor 720 coupled to a computer-readable medium/memory 725. The processor 720 is responsible for general processing, including the execution of software stored on the computer-readable medium/memory 725. The software, when executed by the processor 720, causes the processing system 710 to perform the various functions described herein for any particular apparatus. The computer-readable medium/memory 725 may also be used for storing data that is manipulated by the processor 720 when executing software. The processing system further includes at least one of the illustrated components. The components may be software modules running in the processor 720, resident/stored in the computer readable medium/memory 725, one or more hardware modules coupled to the processor 720, or some combination thereof.

In some aspects, the processing system 710 may be a component of the UE 120 and may include the memory 282 and/or at least one of the TX MIMO processor 266, the receive (RX) processor 258, and/or the controller/processor 280. In some aspects, the apparatus 705 for wireless communication includes means for identifying a first throughput estimate using a first throughput estimation technique based at least in part on a threshold being satisfied at a first time, wherein the threshold is adjustable based at least in part on a scheduling rate of the UE; means for identifying a second throughput estimate using a second throughput estimation technique based at least in part on the threshold not being satisfied at a second time; and means for communicating based at least in part on the first throughput estimate or the second throughput estimate. The aforementioned means may be one or more of the aforementioned components of the apparatus 600 and/or the processing system 710 of the apparatus 705 configured to perform the functions recited by the aforementioned means. As described elsewhere herein, the processing system 710 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 7 is provided as an example. Other examples may differ from what is described in connection with FIG. 7.

The following provides an overview of some Aspects of the present disclosure:

Aspect 1: A method of wireless communication performed by a user equipment (UE), comprising: identifying a first throughput estimate using a first throughput estimation technique based at least in part on a threshold being satisfied at a first time, wherein the threshold is adjustable based at least in part on a scheduling rate of the UE; identifying a second throughput estimate using a second throughput estimation technique based at least in part on the threshold not being satisfied at a second time; and communicating based at least in part on the first throughput estimate or the second throughput estimate.

Aspect 2: The method of Aspect 1, wherein the threshold is associated with a value of the scheduling rate.

Aspect 3: The method of any of Aspects 1-2, wherein the threshold is adjustable based at least in part on the scheduling rate and a moving average derived from the scheduling rate.

Aspect 4: The method of Aspect 3, wherein the moving average comprises an exponential moving average.

Aspect 5: The method of Aspect 3, wherein the moving average is based at least in part on a moving average convergence divergence technique.

Aspect 6: The method of any of Aspects 1-5, wherein the first throughput estimation technique is based at least in part on an observed data rate at a layer of the UE higher than a physical layer.

Aspect 7: The method of any of Aspects 1-6, wherein the second throughput estimation technique is based at least in part on the scheduling rate and a power headroom of the UE.

Aspect 8: The method of any of Aspects 1-7, further comprising switching between the first throughput estimation technique and the second throughput estimation technique based at least in part on a current value of the threshold.

Aspect 9: The method of any of Aspects 1-8, further comprising determining the threshold based at least in part on the scheduling rate.

Aspect 10: An apparatus for wireless communication at a device, comprising a processor; memory coupled with the processor; and instructions stored in the memory and executable by the processor to cause the apparatus to perform the method of one or more of Aspects 1-9.

Aspect 11: A device for wireless communication, comprising a memory and one or more processors coupled to the memory, the one or more processors configured to perform the method of one or more of Aspects 1-9.

Aspect 12: An apparatus for wireless communication, comprising at least one means for performing the method of one or more of Aspects 1-9.

Aspect 13: A non-transitory computer-readable medium storing code for wireless communication, the code comprising instructions executable by a processor to perform the method of one or more of Aspects 1-9.

Aspect 14: A non-transitory computer-readable medium storing a set of instructions for wireless communication, the set of instructions comprising one or more instructions that, when executed by one or more processors of a device, cause the device to perform the method of one or more of Aspects 1-9.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
identifying a first throughput estimate using a first throughput estimation technique based at least in part on a threshold being satisfied at a first time, wherein the threshold is adjustable based at least in part on a scheduling rate of the UE;
identifying a second throughput estimate using a second throughput estimation technique based at least in part on the threshold not being satisfied at a second time; and
communicating based at least in part on the first throughput estimate or the second throughput estimate.

2. The method of claim 1, wherein the threshold is associated with a value of the scheduling rate.

3. The method of claim 1, wherein the threshold is adjustable based at least in part on the scheduling rate and a moving average derived from the scheduling rate.

4. The method of claim 3, wherein the moving average comprises an exponential moving average.

5. The method of claim 3, wherein the moving average is based at least in part on a moving average convergence divergence technique.

6. The method of claim 1, wherein the first throughput estimation technique is based at least in part on an observed data rate at a layer of the UE higher than a physical layer.

7. The method of claim 1, wherein the second throughput estimation technique is based at least in part on the scheduling rate and a power headroom of the UE.

8. The method of claim 1, further comprising switching between the first throughput estimation technique and the second throughput estimation technique based at least in part on a current value of the threshold.

9. The method of claim 1, further comprising determining the threshold based at least in part on the scheduling rate.

10. A user equipment (UE) for wireless communication, comprising:
a memory; and
one or more processors, coupled to the memory, configured to:
identify a first throughput estimate using a first throughput estimation technique based at least in part on a threshold being satisfied at a first time, wherein the threshold is adjustable based at least in part on a scheduling rate of the UE;
identify a second throughput estimate using a second throughput estimation technique based at least in part on the threshold not being satisfied at a second time; and
communicate based at least in part on the first throughput estimate or the second throughput estimate.

11. The UE of claim 10, wherein the threshold is associated with a value of the scheduling rate.

12. The UE of claim 10, wherein the threshold is adjustable based at least in part on the scheduling rate and a moving average derived from the scheduling rate.

13. The UE of claim 12, wherein the moving average comprises an exponential moving average.

14. The UE of claim 12, wherein the moving average is based at least in part on a moving average convergence divergence technique.

15. The UE of claim 10, wherein the first throughput estimation technique is based at least in part on an observed data rate at a layer of the UE higher than a physical layer.

16. The UE of claim 10, wherein the second throughput estimation technique is based at least in part on the scheduling rate and a power headroom of the UE.

17. The UE of claim 10, wherein the one or more processors are further configured to switch between the first throughput estimation technique and the second throughput estimation technique based at least in part on a current value of the threshold.

18. The UE of claim 10, wherein the one or more processors are further configured to determine the threshold based at least in part on the scheduling rate.

19. A non-transitory computer-readable medium storing a set of instructions for wireless communication, the set of instructions comprising:
one or more instructions that, when executed by one or more processors of a user equipment (UE), cause the UE to:
identify a first throughput estimate using a first throughput estimation technique based at least in part on a threshold being satisfied at a first time, wherein the threshold is adjustable based at least in part on a scheduling rate of the UE;
identify a second throughput estimate using a second throughput estimation technique based at least in part on the threshold not being satisfied at a second time; and
communicate based at least in part on the first throughput estimate or the second throughput estimate.

20. The non-transitory computer-readable medium of claim 19, wherein the threshold is associated with a value of the scheduling rate.

21. The non-transitory computer-readable medium of claim 19, wherein the threshold is adjustable based at least in part on the scheduling rate and a moving average derived from the scheduling rate.

22. The non-transitory computer-readable medium of claim 21, wherein the moving average comprises an exponential moving average.

23. The non-transitory computer-readable medium of claim 21, wherein the moving average is based at least in part on a moving average convergence divergence technique.

24. The non-transitory computer-readable medium of claim 19, wherein the first throughput estimation technique is based at least in part on an observed data rate at a layer of the UE higher than a physical layer.

25. The non-transitory computer-readable medium of claim 19, wherein the second throughput estimation technique is based at least in part on the scheduling rate and a power headroom of the UE.

26. The non-transitory computer-readable medium of claim 19, wherein the one or more instructions further cause the UE to switch between the first throughput estimation technique and the second throughput estimation technique based at least in part on a current value of the threshold.

27. The non-transitory computer-readable medium of claim 19, wherein the one or more instructions further cause the UE to determine the threshold based at least in part on the scheduling rate.

28. An apparatus for wireless communication, comprising:
means for identifying a first throughput estimate using a first throughput estimation technique based at least in part on a threshold being satisfied at a first time, wherein the threshold is adjustable based at least in part on a scheduling rate of the apparatus;
means for identifying a second throughput estimate using a second throughput estimation technique based at least in part on the threshold not being satisfied at a second time; and
means for communicating based at least in part on the first throughput estimate or the second throughput estimate.

29. The apparatus of claim 28, wherein the threshold is associated with a value of the scheduling rate.

30. The apparatus of claim 28, wherein the threshold is adjustable based at least in part on the scheduling rate and a moving average derived from the scheduling rate.
